(19) United States
(12) Patent Application Publication
(10) Pub. No.: US 2005/0231585 A1
(43) Pub. Date: Oct. 20, 2005

(54) Method and system for laser imaging utilizing low power lasers

(76) Inventors: Dhurjati S. Mudigonda, Westerville, OH (US); Ashley S. Scott, Grove City, OH (US); Lori A. Rigsby, Waverly, OH (US)

Correspondence Address: THOMPSON HINE L.L.P., 2000 COURTHOUSE PLAZA , N.E., 10 WEST SECOND STREET, DAYTON, OH, 45402, US

(21) Appl. No.: 11/070,828

(22) Filed: Mar. 2, 2005

Related U.S. Application Data
(60) Provisional application No. 60/549,290, filed on Mar. 2, 2004.

(51) Int. Cl. B41J 2/45

(52) U.S. Cl. 347/238

(57) ABSTRACT

A method and system for direct laser imaging using a low power laser is described. In one aspect, the method includes irradiating a laser markable material with a laser at a power of less than about 1 Watt to form a mark.

### REFERENCE TO RELATED APPLICATION

This application claims the benefit of U.S. Provisional Application No. 60/549,290 filed Mar. 2, 2004, the disclosure of which is incorporated herein by reference.

### BACKGROUND OF THE INVENTION

The present invention generally relates to a method and system for direct laser imaging using a low power laser. More specifically, in accordance with one aspect of the present invention, a system for laser imaging is provided wherein a laser image is obtained utilizing a diode array laser having a power of less than 1 Watt/diode.

One of the most widely commercialized applications of lasers since their discovery has been in the area of laser markings. The principle behind the laser marking is the ability of lasers to make an observable change in the material upon which the laser energy is focused. For typical applications, the material to be imaged should absorb in the wavelength region of the interacting laser for an observable change to occur. When the material absorbs the energy, a number of processes can occur depending on the wavelength, power of the laser and the efficiency of absorption of the material. Ultraviolet lasers, with energy levels above 3 eV (or wavelength below 400 nm), generally cause photochemical reactions in the absorbed material whereas infrared lasers, with energy levels below 1.54 eV (or wavelength above 800 nm), generally cause thermal reactions. Among the IR lasers, CO₂ lasers are most studied and commercialized extensively. However, CO₂ laser being an IR laser, multiple photon absorptions are required for the absorbing material to undergo dissociation at molecular level. Thus, higher power CO₂ lasers are required for most applications. Another important class of IR lasers is based on diode lasers. The cost of a laser system is heavily dependent upon the power (or wattage) required of the system. Thus, lower power lasers (<1 Watt) may be preferred for economical reasons. Among the low powered lasers, diode lasers are among the most popular for the many benefits that they offer such as higher efficiency, long lifetime, maintenance free and low cost.

U.S. Pat. Publication No. 2003/0180660 A1 to Khan describes a method of achieving laser marks using a CO₂ laser operating at a frequency of 10,600 mn. U.S. Pat. Publication No. 2003/0186001 A1 also to Khan describes a method for marking an object by directing a laser beam on to the object, which includes a material with a functional group and a metal compound, or acid that causes an elimination reaction on irradiation. The examples set forth in the published application utilize a CO₂ laser operating at from 3 to 10 Watts.

International Publication No. WO 02/074548 to Khan discloses a laser-markable composition comprising a binder and an oxyanion of a multivalent metal such as ammonium octamolybdate (AOM). Specific examples of the compositions were imaged with a CO₂ laser at an output power of 3-4 Watts. It would be desirable to develop methods and compounds that could be used for laser marking using low powered (<1 Watt) laser systems.

### SUMMARY OF THE INVENTION

The present invention relates to a method and system for direct laser marking using a low power laser. More specifically, in accordance with one aspect of the present invention, a system for laser marking is provided wherein a laser mark is obtained utilizing a diode array laser having less than about 1 Watt/diode. In accordance with a particular aspect of the invention, a laser markable material is imaged by a method comprising the steps of:
(a) providing a laser markable material; and
(b) irradiating the laser markable material with a laser at a power of less than about 1 Watt to form a mark.

In accordance with a particular embodiment of the present invention, the method for marking a laser markable material comprises marking the material at a print speed of greater than about 0.5 inches /sec.

The present invention also relates to a laser markable material comprising a laser markable composition. The laser markable composition may include an oxyanion of a multivalent metal and a reducing agent. In accordance with certain embodiments of the present invention, the oxyanion of a multivalent metal comprises ammonium octamolybdate. The laser markable material may also comprise a substrate. The laser markable composition can be integral with the substrate or a separate layer or coating on the substrate.

In accordance with particular embodiments of the present invention, the laser used in irradiating the laser markable material is a diode laser operating at a wavelength between about 800 nm to 1500 nm and at a power of less than about 1 Watt/diode.

Particular aspects of the invention will become apparent from the following description.

### DETAILED DESCRIPTION OF THE INVENTION

All documents cited are, in relevant part, incorporated herein by reference; the citation of any document is not to be construed as an admission that it is prior art with respect to the present invention.

The term “mark” as used herein refers to a detectable change in color or density of the laser irradiated area as compared to surrounding areas of the laser markable material that were not irradiated with the laser.

Although not wishing to be bound by theory, analysis of a typical laser marking process utilizing the oxyanion of a multivalent metal such as ammonium octamolybdate indicates that there are potentially two stages that occur during the laser marking. A color change that is caused by the formation of mixed valent metal ions, typically yielding a blue color followed by an irreversible degradation product that is black colored. When a laser is irradiated upon the octamolybdate, molybdenum is partially reduced from its +VI oxidation state to +V state during the process of oxygen elimination. Thus, a part of the laser energy is consumed in this reaction (for stage 1 of the process). Additives that can donate electrons (e.g., reducing agents) at ambient conditions or at higher temperatures can therefore assist the laser marking process in that the laser energy required is mostly used for the stage 2 of the marking process which is to obtain a dark colored product. The efficiency of the reducing agent is dependent on the electrode potential of the material and the temperature. Therefore, an appropriate reducing agent can be chosen to fine-tune the energy requirements for the laser marking process depending on the application and the temperatures involved in the marking process. Further reduction in the energy threshold requirements for the laser marking can be achieved through the addition of an absorber that would capture the radiation and convert it into thermal energy.

The lasers useful in accordance with certain aspects of this invention are low power (from about 1 mW to about 1 Watt) lasers capable of imaging the laser markable materials disclosed herein. The lasers typically operate at from about 800 nm to 1500 nm. Although more powerful lasers may image the materials described herein, some of the advantages associated with the present invention are obtained when using low power lasers operating at from less than about 1 Watt, more particularly less than about 500 mW and still more particularly less than about 250 mW. Satisfactory marks or images have been obtained using a diode array laser operating at 980 nm with about 400 mW per diode or even at about 100 mW per diode. Suitable lasers are commercially available from Thorlabs, Inc., 435 Route 306 North, Newton, N.J. 07860, USA.

In accordance with certain embodiments of the present invention, a compact, low power direct laser imaging system is provided which can be used in applications that typically rely on printing techniques such as impact printing, thermal transfer, direct thermal and ink jet printing. The imaging system described above is especially suitable for use in the present invention for exposure using a diode laser array driven by an electronic signal for the generation of images from a computer or other digital source. Direct laser imaging systems as set forth herein may be particularly useful in applications such as, but not limited to, point of sale (POS) systems, labels, tags, tickets, security papers, coupons, decorative surfaces, medical products, office documents, toner based papers, etc.

The laser markable material may include a substrate which may comprise any material typically used for the various applications as set forth above including, but not limited to, paper, plastic (film), paper/film composite, laminate, and board. The substrate and laser markable composition can be provided as separate layers or the laser markable composition can be incorporated into the substrate. For example, the laser markable composition could be incorporated in the fibers during the paper making process or in the plastic melt used to form a film substrate. When coating the laser markable composition on the substrate, various methods may be employed, such as curtain coating, blade, bar, rod, air knife, roll, jet, spray, extrusion, brush roller and dip. The laser markable composition will typically be present in an amount sufficient to produce a visible image of the desired density upon irradiation with the laser. The laser markable composition will typically be coated or incorporated into the substrate at weights from about 0.5 to about 20 g/m², more particularly from about 3 to about 15 g/m² dry weight.

The laser markable composition in accordance with certain embodiments includes an oxyanion of a multivalent metal. Examples of useful cations in the oxyanion-containing material include ammonium, an alkali or an alkaline earth metal. The oxyanion may be a molybdate, tungstate or analogous transition metal compounds. Examples of useful molybdates include di- and hepta-molybdates. Ammonium octamolybdate (AOM) is particularly useful. Although the following discussion centers on the use of AOM, the present invention is not to be construed as being limited to AOM. In general, the laser markable composition will include an amount of an oxyanion of a multivalent metal sufficient to produce visible imaging at the applied irradiation level and print speed. These amounts typically range from approximately 1 to about 90 percent, more particularly from about 10 to 40 percent by weight based on the total dry weight of the laser markable composition. A particularly useful range is from about 15 percent to about 35 percent. The amount of the material required to obtain suitable images depends on the nature of the material, the nature of the substrate, and the specifics of the laser imaging system.

A suitable binder may be mixed with the AOM, typically in an amount of about 1 to 90%, more particularly from about 5 to 20 percent and still more typically from about 10 to 15 percent by weight of the laser markable composition, to prepare a laser markable coating composition. Specific examples of useful binders include, but are not limited to, acrylics, celluloses, PVOH, polyesters, SBR latices, alginate, starch, protein, etc. and combinations thereof. Particularly useful binders include acrylic binders such as RHOPLEX E-358 available from Rohm Nova and styrene butadiene latex binders such as GENFLO 1500 also available from Rohm Nova.

The laser markable composition may also include a reducing agent or electron donor which facilitates the laser imaging process. Reducing agents useful in the present invention typically will have a redox potential of about 0±2 V vs. SCE (standard calomel electrode) at room temperature. Specific examples of reducing agents which are suitable for use in the present invention include, without limitation, Na₂SO₃, Na₂S₂O₃, NH₂OH, N₂H₄, NaBH₄, Na₂S₂O₄, thiourea dioxide and mixtures thereof. The reducing agent, when included in the laser markable composition, will typically be present in an amount of about 0.1 to 50 percent, more particularly from about 5 to 20 percent and still more typically from about 7 to 12 percent by weight. Reducing agent can be combined in the coating mixture prior to the application of coating but it can also be combined in a grinding process or through a process of milling inclusive of jet milling and possibly spray drying.

The laser markable composition may also include a near IR absorber which absorbs IR radiation and converts it into heat thereby facilitating marking at lower energy thresholds. IR absorbers are described in the prior art and include transition metal salts, sulfides, clays, micas, TiO₂, carbonates, oxides, talc, silicates, aluminosilicates, dyes, metal complex dyes, conducting polymers and combinations thereof. Transition metal salts that may be used include copper, iron, and nickel salts. Examples of specific dyes include cyanine dyes and quinone dyes. Lead (II) sulfide is a particularly useful IR absorber. The IR absorber, when present, may be included in the laser markable composition in an amount of from about 0.1 to 90 percent, more particularly from about 1 to 20 percent and still more typically from about 5 to 10 percent by weight.

In accordance with certain embodiments of the present invention, the laser markable coating composition may include one or more additives to improve coating or imaging properties. Examples of particular types of additives include, but are not limited to, binders, surface tension modifiers, leveling agents, rheology modifiers, crosslinkers, insolubilizers, dyes, tinting agents, optical brighteners, pH stabilizers, buffers, antifoamers, clays, carbonates, diluent pigments, thermally conductive diluents, defoamers, antioxidants, biocides and lubricants.

The coating formulations can be prepared in accordance with conventional coating preparation techniques. The coating formulation may be water-based, solvent-based or UV-curable. The formulation may be in the form of a solution or a dispersion.

In accordance with one aspect of the present invention, a system for laser marking is provided. A laser mark is obtained by irradiating a laser markable material with a laser operating at a power of less than about 1 Watt. The marks in accordance with certain embodiments are permanent. In accordance with a particular aspect of the invention, a laser markable material is imaged by a method comprising the steps of:
(a) providing a laser markable material; and
(b) irradiating the laser markable material with a laser at a power of less than about 1 Watt to form a mark.

In accordance with a particular embodiment of the present invention, the method for marking a laser markable material comprises marking the material at a print speed of greater than about 0.5 inches/sec, more particularly greater than about 1 inch/sec and in accordance with certain embodiments greater than about 100 inches/sec. In accordance with this embodiment, the laser markable material may comprise a laser markable composition coated on or incorporated in a paper or film substrate which is advanced past a laser diode print head at the designated speed and imaged. The print head may be a diode array composed of individual diodes with powers ranging from about 50 to 200 mW, more particularly from about 75 to 100 mW. The arrays may be stitched together into a staggered or single row and placed in front of an optical lens system in order to focus the laser light onto the surface of the moving laser markable substrate at the corresponding print speeds. Alternatively, the laser markable substrate could be stationary and the aforementioned laser print head and optical lens system may be moved relative to the laser markable substrate at the corresponding print speed. Furthermore, the laser print head may be a single diode that generates a beam that is directed through a collimator lens onto a rotating polygon mirror (scanner). The polygon mirror can then reflect the laser beam through a scanning lens system in order to focus the laser light onto the surface of the moving laser markable substrate.

The laser imaging system of the present invention can generate a variety of marks such as numerals, letters, symbols, and graphics. The laser imaging system can also be used to generate human readable or machine readable codes such as one or two dimensional bar codes.

The present invention is illustrated in more detail by the following non-limiting examples:

### EXAMPLES 1-7

Chemicals:

Ammonium Octamolybdate (AOM) was obtained from HC Stark. Rhoplex E-358, (Binder 1) was obtained from RohmNova. JONREZ E-2005, an acrylic binder, (Binder 2) was obtained from MeadWestvaco Corp, specialty Chemicals division. Genflo 1500 (Binder 3) was obtained from RohmNova; Thiourea Dioxide, was obtained from Wego Chemical & Mineral Corp. Lead (II) Sulfide (Pb S, NIR absorber) was obtained from Aldrich.

Formulations:

Formulations were made using the chemicals and weight percentages shown in Table 1. The mixture was thoroughly mixed in a laboratory blender for 10 minutes at 21,000 rpm.

TABLE 1
Coating Formulations

| | Formulation 1 | Formulation 2 | Formulation 3 | Formulation 4 | Formulation 5 | Formulation 6 | Formulation 7 |
|---|---|---|---|---|---|---|---|
| | Wt | Wt | Wt | Wt | Wt | Wt | Wt |
| Chemical | Percentage | Percentage | Percentage | Percentage | Percentage | Percentage | Percentage |
| Ammonium | 35.2% | 35.2% | 39.5% | 34.1% | 34.1% | 34.1% | 31.2% |
| octamolybdate | | | | | | | |
| PbS, NIR Absorber | 3.5% | 3.5% | 1% | 3.4% | 3.4% | 3.4% | 3% |
| Thiourea dioxide | — | — | 1% | 3.4% | 3.4% | 3.4% | 3% |
| Binder 1 | 38.6% | — | 43.3% | 37.3% | — | — | 32.7% |
| Binder 2 | — | 38.6% | — | — | 37.3% | — | — |
| Binder 3 | — | — | — | — | — | 37.2% | — |
| Pigment, Kaolin | — | — | — | — | — | — | 10.9% |
| Clay | | | | | | | |
| Water | 22.7% | 22.7% | 15.2% | 21.9% | 21.9% | 21.9% | 19.2% |

The formulation was then applied onto a cellulose substrate at a dry coat weight in the range of about 3-15 g/m² by the use of a meyer rod coating machine.

Laser Marking:

Laser-marking experiments were carried out on a custom built laser system consisting of 46 emitters operating at 980 nm capable of producing a maximum combined output power of 20 W.

Samples were marked at a print speed of less than 10 inches per second for a time period of less than 1 second with a spot size of about 500 mm-1 mm. The distance from the laser to the paper depends on the optics used to achieve the target spot size. For this example, it was approximately 1 mm from the paper surface. Results of the marking experiments are shown in Table 2.

TABLE 2
Laser Marking Experiments

| Coating | Laser Power/diode | Color of Mark |
|---|---|---|
| Formulation 1 | 0.434 W | Black |
| Formulation 2 | 0.434 W | Black |
| Formulation 3 | 0.434 W | Black |
| Formulation 4 | 0.108 W | Black |
| Formulation 5 | 0.108 W | Black |
| Formulation 6 | 0.108 W | Black |
| Formulation 7 | 0.434 W | Black |

Various formulations were made to evaluate their effects on the laser marking process. Formulations 1 and 2 were made only with an NIR additive and the other formulations were made with NIR additive and thiourea dioxide (reducing agent). The laser marks obtained in each case were black in color and appeared to possess crisp edges. The lower threshold observed for the formulations 4, 5 and 6 (0.108 W) is likely due to the reducing agent facilitating the first stage of the laser marking process. This advancement is significant in that the power requirements on the laser for obtaining laser-markings is substantially lower than the earlier reported values, thus, making this technology accessible to markets that require such a criterion (e.g., thermal paper/printing markets).

### EXAMPLE 8

The enhancement in marking efficiency by the use of reducing agents is illustrated in the following example. A Nd³⁺: YAG CW laser operating at 1064 nm is used for the study. The CW laser was chopped externally using an Acousto Optic Modulator to produce pulses of desired pulse widths (1 ms). The energy in the pulse was measured as being 80 μj using a joule meter (80 mW). Two samples were used for the study: sample 1 containing ammonium octa molybdate (AOM) and copper hydroxide phosphate (CHP) at 1:4 weight ratio and sample 2 containing AOM:CHP at 1:4 weight ratio and about 10% by weight of a reducing agent (sodium hydrosulfite) based on the weight of AOM. The coat weight of the samples were comparable and within the range of 4-15 g/m². The laser mark obtained with Sample 2 resulted in a clear increase in the image size marked, demonstrating the improvement attributable to the reducing agent. As indicated in Table 3, the area enhancement obtained with the reducing agent is about 80% in this example.

TABLE 3

| | Spot Diameter | Spot Area |
|---|---|---|
| Sample | (μm) | (μm²) |
| 1 | 41 | 1297 |
| 2 | 55 | 2346 |

Further, as the efficiency of the reducing agents is partly dependent on the temperature, fine-tuning of the requirements for the laser power can be achieved. Such an ability to fine tune the laser power can be exploited in selective activation of a compound for laser marking in a formulation containing more than one laser-active material. A potential use of such a technology will be in the area of multi-colored printing and desktop publication.

1. A method for marking a laser markable material comprising:
providing a laser markable material; and
irradiating the laser markable material with a laser at a power of less than about 1 Watt to form a mark on the laser markable material.

2. The method of claim 1 wherein the laser markable material is irradiated at a print speed of greater than about 0.5 inches/sec.

3. The method of claim 2 wherein said print speed is greater than about 100 inches/sec.

4. The method of claim 1 wherein the laser markable material comprises a laser markable composition on a paper substrate, film substrate or paper/film composite.

5. The method of claim 1 wherein the laser comprises a laser diode.

6. The method of claim 5 wherein the laser comprises a diode array composed of individual diodes wherein the power of each undivided diode is between about 50 and 200 mW.

7. The method of claim 6 wherein the power of each individual diode is between about 75 and 100 mW.

8. The method of claim 1 wherein the laser markable material comprises an oxyanion of a multivalent metal and a reducing agent.

9. The method of claim 8 wherein the oxyanion of a multivalent metal comprises ammonium octamolybdate.

10. The method of claim 1 wherein the laser markable material comprises a laser markable composition integral with a paper or film substrate.

11. The method of claim 1 wherein the laser comprises a diode laser operating at a wavelength between about 800 nm to 1500 nm.

12. The method of claim 1 wherein the laser markable material comprises a laser markable composition and a substrate, the laser markable composition comprising an oxyanion of a multivalent metal and a reducing agent.

13. The method of claim 12 wherein the reducing agent has a redox potential of about 0±2 V vs. SCE (standard calomel electrode) at room temperature.

14. The method of claim 13 wherein the reducing agent is selected from the group consisting of Na₂SO₃, Na₂S₂O₃, NH₂OH, N₂H₄, NaBH₄, Na₂S₂O₄, thiourea dioxide and mixtures thereof.

15. The method of claim 12 wherein the reducing agent is present in an amount of about 0.1 to 50 percent by weight of the laser markable composition.

16. The method of claim 12 wherein the laser markable composition further comprises a near IR absorber.

17. The method of claim 16 wherein the near IR absorber is selected from the group consisting of transition metal salts, sulfides, clays, micas, TiO₂, carbonates, oxides, talc, silicates, aluminosilicates, dyes, metal complex dyes, conducting polymers and combinations thereof.

18. The method of claim 16 wherein the near IR absorber is present in the laser markable composition in an amount from about 1 to 20 percent by weight.

19. A laser markable material comprising a laser markable composition and a substrate wherein the laser markable composition comprises an oxyanion of a multivalent metal and a reducing agent and the laser markable composition when irradiated with a laser at a power of less than about 1 Watt produces a mark.

20. The laser markable material of claim 19 wherein the oxyanion of a multivalent metal comprises ammonium octamolybdate.

21. The laser markable material of claim 19 wherein the laser markable material comprises from about 0.5 to about 20 g/m² of the laser markable composition.

22. The laser markable material of claim 21 wherein the laser markable composition is coated on the substrate.

23. The laser markable material of claim 22 wherein the substrate comprises paper.

24. The laser markable material of claim 19 wherein the reducing agent is selected from the group consisting of Na₂SO₃, Na₂S₂O₃, NH₂OH, N₂H₄, NaBH₄, Na₂S₂O₄, thiourea dioxide and mixtures thereof.

25. The laser markable material of claim 19 wherein the laser markable composition further comprises a near IR absorber.

26. The laser markable material of claim 25 wherein the laser markable composition is coated on the substrate.

27. The laser markable material of claim 19 wherein the laser markable composition further comprises a binder.

28. The laser markable material of claim 27 wherein the binder is selected from the group consisting of acrylics, celluloses, polyvinyl alcohol, polyesters, SBR latices, alginate, starch, protein and mixtures thereof.

29. The laser markable material of claim 28 wherein the binder comprises an acrylic binder.

30. The laser markable material of claim 28 wherein wherein the laser markable composition further comprises a near IR absorber.

31. The laser markable material of claim 30 wherein the oxyanion of a multivalent metal comprises ammonium octamolybdate and the reducing agent comprises thiourea dioxide.
